(19) United States
(12) Patent Application Publication
(10) Pub. No.: US 2015/0348387 A1
(43) Pub. Date: Dec. 3, 2015

(54) System and Method Of Motion Detection And Secondary Measurements

(71) Applicant: Honeywell International Inc., Morristown, NJ (US)

(72) Inventors: Daniel J. Sheflin, Ponce Inlet, FL (US); Kenneth L. Addy, Massapequa, NY (US); Aravind Padmanabhan, Plymouth, MN (US)

(73) Assignee: Honeywell International Inc., Morristown, NJ (US)

(21) Appl. No.: 14/293,517

(22) Filed: Jun. 2, 2014

(51) Int. Cl. G08B 19/00; G08B 1/08; G08B 25/10

(52) U.S. Cl. CPC G08B 19/00; G08B 25/10; G08B 1/08

(57) ABSTRACT

A regional monitoring system in communication with a plurality of locally displaced detectors can implement a fusion of inputs from a variety of additional, non-system devices. The monitoring system includes a wireless receiver, or transceiver, enabling it to detect local traffic from the non-system devices, such as sensors. Information received from such non-system devices can be combined with information from system detectors to initiate activity on other networks, to energize actuators, or to activate system detectors that normally reside in a low energy, inactive, state.

### FIELD

The application pertains to monitoring systems. More particularly, the invention pertains to such systems that can monitor selected conditions in a region, and can take into account local wireless traffic, not part of the respective monitoring system, in making a determination as to the existence of one or more predetermined conditions.

### BACKGROUND

Known security monitoring systems currently make decisions based on the inputs from security related detectors distributed around a building. These might include motion detectors, pressure mats, door contacts and the like all without limitation. Other types of signals emitted by non-system devices might contain other types of information which could be used, if accessible, advantageously by a local monitoring system.

### BRIEF DESCRIPTION OF THE DRAWINGS

FIG. 1 illustrates a block diagram of a system in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Many commercial buildings and residences contain one or more monitoring systems. Increasingly, commercial buildings and residences include additional devices, or detectors, that include sensors that are not part of the security system. For example a motion detector in a thermostat, a camera system in a gaming console, cameras and microphones in computers, telephones, external lighting, temperature sensors, weather stations all without limitation.

Such systems, based on existing conditions are usually capable of energizing various types of actuators to unlock or close doors, or to energize camera recording systems.

Embodiments hereof improve aspects of the operation of such systems by fusing inputs from a variety of additional sensors that may not directly be part of the security system. These additional detected inputs could improve security system determinations by providing additional inputs that can be included in a decision making process.

In accordance with the above, the reliability of a detected alarm can be improved, thereby reducing false alarms. For example, information gathered from other sensors in the building or region being monitored, such as, recent historical data, along with readings for several seconds after an alarm determination has been made can be taken into account before making a decision to call first responders. In this regard, the secondary measurements, or information, could be “weighted” and combined to make a final decision.

In one aspect, since security systems are “always on” by nature, to provide 24/7 coverage, security system processing could initiate activity on other non-security networks. To improve the QOS/reliability of wi-fi alarm messages, an alarm trigger culd be used to turn-off the wi-fi activity from other devices in the region of interest. An example might be a dongle in the USB port of a router that shuts off all other traffic except streaming video from security cameras.

In another aspect, signals from non-system sources can be used as a basis for actuating security system devices, which can normally be in a low energy default state, to extend useful battery life. For example, to improve battery lifetime of wireless devices, higher current, battery powered devices, such as wireless cameras, can be placed into a very low current state until awakened by a signal from a device which is continuously powered.

The above requires an underlying wireless network with always-on nodes to collect and reformat messages into a protocol for synchronized, “paging” of mostly-off devices. An example might be to use a USB Tx/Rx plugged into a gaming system that detects/sees human activity and, in response thereto, wakes up, energizes, the wireless cameras in other parts of a home.

Additional embodiments, without limitation include, providing control of actuators by a variety of sensors that may or may not be part of the actuation system. In this regard, a CO detector which has gone into alarm can be used to turn on air conditioning and an associated fan to rapidly refresh the air in an area. Coverings, such as blinds or drapes can be closed if a room is becoming too warm due to sunlight. Alternately, in winter, if furnace is running, criteria could be incorporated to automatically close the coverings then to reduce heating expenses, or the widows can also be locked in such conditions.

In another aspect, wirelessly controlled doors, such as z-wave operated doors, can be unlocked in an alarm event. This could prevent axe damage from first responders.

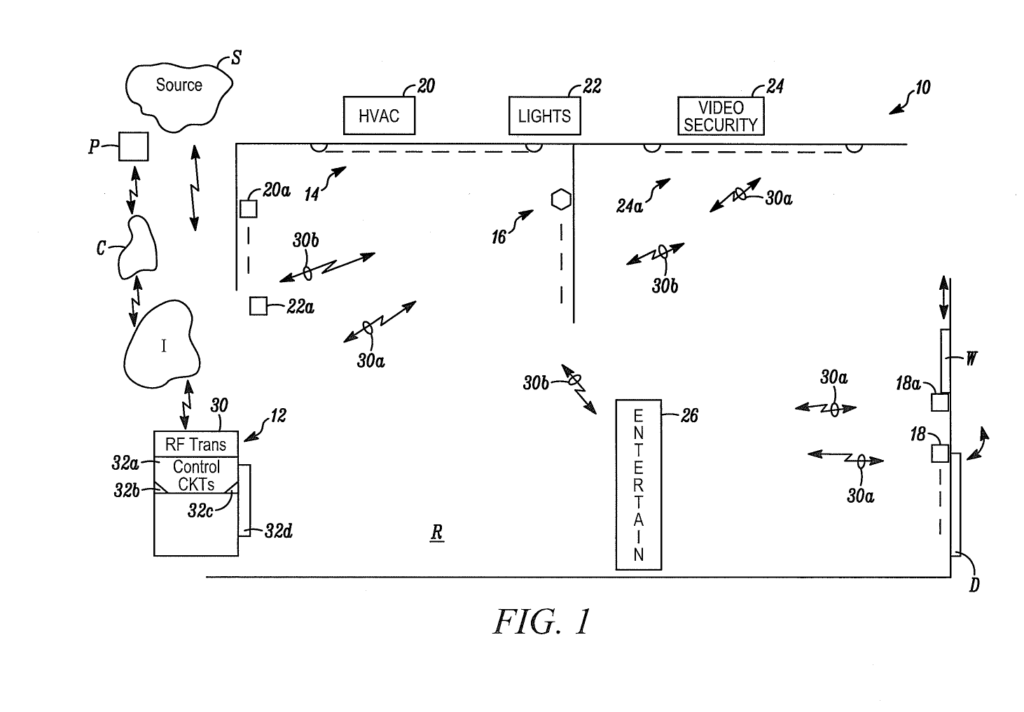

FIG. 1 illustrates a block diagram of a system 10 in accordance herewith. A region R is being monitored by a monitoring system 12. Monitoring system 12 can communicate, wired or wirelessly, with a plurality of ambient condition detectors such as fire, smoke or gas detectors 14 as well as with a plurality of intrusion detectors 16 which sense motion, position or audio all as would be understood by those of skill in the art.

System 12 can also be in wired, or wireless communications with a variety of actuators including door control, locking and unlocking, systems 18 for doors such as door D, or window locking, unlocking, opening or closing systems 18a for windows W. Other types of actuators could include fans, pumps or the like all without limitation.

It will also be understood that other types of monitoring systems such as heating ventilating air conditioning systems (HVAC) 20 (with one or more wireless thermostats 20a), lighting control systems 22, (with one or more wireless illumination sensors 22a), or video security imaging systems 24 (with cameras 24a), could also be used in the region R along with entertainment system 26.

The monitoring system 12 can include a wireless RF transceiver 30 for wireless communications 30a with the various units 14, 16, 18, where those units are part of the monitoring system 12. The transceiver 30 can also communicate directly 30b, or via the Internet I with internet enabled members of the pluralities 14, 16, 18, 18a.

Other types of systems, such as systems 20, 22, 24, 26 without limitation, in or in the vicinity of the region R are not part of the monitoring system 12. All such systems 20, 22, 24, 26 might emit wireless signals such as 30b detectable by transceiver 30. Similarly, the related wireless control units 20a, 22a could also emit detectable signals 30b.

Monitoring system 12 can also include control circuits 32a coupled to the transceiver 30. Control circuits 32a can be implemented at least in part by one or more programmable processors 32b along with executable instructions 32c. A manually operable control panel and visual display 32d can be coupled to the control circuits 32a via a wired or wireless interface.

In summary, wired or wireless signals from those members of the pluralities 14, 16, 18, that are not part of system 12, as well as other systems such as 20, 22, 24, 26 and their respective wireless control units such as 20a, 22a can be detected by system 12. These signals, can be incorporated, as discussed above into making alarm determinations, activating devices in a non-active state, or energizing actuators to open or close doors, windows, operate fans turn lights on or off, enable video cameras or the like without being part of the system 12.

In yet another aspect, the units which are not part of the local system, such as system 12, can be physically displaced from system 12. They can include internet enabled sources S or cellular-type units P which can communicate via a local cell system C. In this regard, user activity in one location can via the internet or cellular systems, such as system C, can trigger events in a different system. For example, locking an office door at work can be communicated to a home security system such as system 12, to turn on heat, lights, or report security system/video status back to a mobile phone, such as cellular unit P. Hence, remote as well as local event-actions can be responded to by a local system, such as system 12.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims

1. An apparatus comprising:
a regional monitoring system which includes a plurality of detectors; and
circuitry to respond to at least one unit not part of the system, wherein the at least one unit emits wireless signals which are received by the circuitry which, responsive thereto, at least in part, implements a function selected from a class which includes at least, one of, altering an operational element or process of the system, emitting a condition indicating signal, energizing an actuator, or activating at least some of the detectors for at least intermittent operation.

2. An apparatus as in claim 1 wherein the detectors are selected from a class which includes at least motion detectors, PIR detectors, position detectors, glass break detectors, airborne condition detectors, temperature detectors, and lighting detectors.

3. An apparatus as in claim 1 wherein one of the monitoring system circuitry, or the units emits signals to switch selected ones of the detectors from a low power inactive state to a higher power active state.

4. An apparatus as in claim 1 wherein an alarm indicating process responds to signals from at least one of the detectors and signals from the at least one unit.

5. An apparatus as in claim 1 where the monitoring system circuitry can monitor local, non-security related traffic, and wherein the unit can include one or more broadband, or cellular-type devices, displaced from the monitoring system but which can communicate with the circuitry.

6. An apparatus as in claim 1 where the system is selected from a class which includes at least, a security monitoring system, an airborne condition monitoring system, a heating ventilating air conditioning system, an illumination control and monitoring system, an entertainment system and, a communications system

7. An apparatus as in claim 1 wherein an actuator can be energized in response to a signal from the at least one unit to unlock a door, change the operational state of a fan, open or close a shade or covering, lock or unlock windows.

8. An apparatus as in claim 7 wherein one of the monitoring system circuitry, or the units emits signals to switch selected ones of the detectors from a low power inactive state to a higher power active state.

9. An apparatus as in claim 8 wherein the detectors are selected from a class which includes at least motion detectors, PIR detectors, position detectors, glass break detectors, airborne condition detectors, temperature detectors, and lighting detectors.

10. An apparatus comprising:
a regional monitoring system which includes circuitry to receive signals emitted by at least one wireless signal emitting device not part of the system, wherein when the monitoring system receives at least some of the emitted signals it incorporates information therefrom into an alarm indicating determination.

11. An apparatus as in claim 10 where the system includes at least one actuator which is energized as a result of at least one of received airborne information, thermal information, movement information, or intrusion related information.

12. An apparatus as in claim 10 where the system includes at least one of a detector or an output device which is energized at least in part, as a result of airborne information obtained by the circuitry.

13. An apparatus as in claim 10 wherein activity can be initiated by the monitoring system on at least one unit not part of the monitoring system.

14. An apparatus as in claim 13 where the at least one unit includes an output unit which is energized at least in part, as a result of information obtained by the circuitry from the at least one wireless signal emitting device.

15. An apparatus comprising:
a monitoring system, the system includes at least a wireless receiver and control circuits coupled thereto; and
the control circuits process received wireless information from other non-system, units and, incorporate such information into making subsequent determinations.

16. An apparatus as in claim 15 wherein subsequent determinations are selected from a class which includes at least, determining the presence of an alarm condition, determining that at least one actuator is to be energized, and determining that at least one detector unit is to be energized.

17. A regional monitoring system comprising circuitry in communication with a plurality of locally displaced detectors, wherein the system can implement a fusion of inputs from a variety of additional, non-system devices and including at least a wireless receiver, enabling the circuitry to detect local traffic from the non-system devices, wherein information received from such non-system devices can be combined with information from system detectors to at least one of, initiate activity on other networks, to energize actuators, or to activate system detectors that normally reside in a low energy, inactive, state.

18. A system as in claim 17 wherein the non-system devices can include, one or more broadband, or cellular-type devices, displaced from the monitoring system but which can communicate with the circuitry.

19. A system as in claim 18 where user activity in one location can, via the internet or cellular systems, trigger events in the displaced monitoring system.
